(19) United States
(12) Patent Application Publication
(10) Pub. No.: US 2026/0268700 A1
(43) Pub. Date: Sep. 10, 2026

(54) METHOD FOR TRAINING DOCUMENT IMAGE DISTORTION CORRECTION MODEL, AND DOCUMENT IMAGE DISTORTION CORRECTION METHOD AND SYSTEM USING SAME

(71) Applicant: NAVER CORPORATION, Seongnam-si (KR)

(72) Inventors: Chankyu CHOI, Seongnam-si (KR); Seungjae KIM, Seongnam-si (KR); Juhyeok MUN, Seongnam-si (KR); Yeong Hwa JIN, Seongnam-si (KR)

(73) Assignee: NAVER CORPORATION, Seongnam-si (KR)

(21) Appl. No.: 19/666,960

(22) Filed: May 4, 2026

Related U.S. Application Data
(63) Continuation of application No. PCT/KR2024/017471, filed on Nov. 7, 2024.

(30) Foreign Application Priority Data
Jan. 3, 2024 (KR) 10-2024-0000851

(51) Int. Cl. G06V 30/16; G06F 40/58; G06V 10/764; G06V 10/774; G06V 30/146; G06V 30/19; G06V 30/40

(52) U.S. Cl. CPC G06V 30/1607; G06V 10/764; G06V 10/774; G06V 30/1478; G06V 30/19147; G06V 30/40; G06F 40/58

(57) ABSTRACT

The present disclosure provides a method for training a document image distortion correction model, the method being performed by at least one processor. This method includes receiving a first grid dividing a document area into multiple cells on a first image comprising the document area, based the first grid, generating a second grid representing a state in which a distortion of the first image is corrected, generating a backward map calculating a pixel in the first grid corresponding to each pixel in the second grid, and training a document image distortion correction model to generate the backward map from the first image.

### CROSS-REFERENCE TO RELATED APPLICATIONS

This application is a continuation of, and claims the benefit of priority under 35 U.S.C. 365 (c) from International Patent Application No. PCT/KR2024/017471, filed on Nov. 7, 2024 in the World Intellectual Property Organization (WIPO), which designates the United States of America and claims priority benefit from Korean Patent Application No. 10-2024-0000851, filed on Jan. 3, 2024, the disclosures of each of which are incorporated herein by reference in their entireties.

### TECHNICAL FIELD

The present disclosure relates to a method for training a document image distortion correction model, and a method and system for correcting the distortion of a document image using the same and, more specifically, to a method and a system for training a document image distortion correction model to generate a backward map used to correct the distortion of a document image and for correcting the distortion of the document image using the backward map generated by the trained model.

### BACKGROUND

Recently, as the performance of a camera equipped in a smartphone has improved, it is possible to capture a document using the camera of the smartphone instead of an optical scanner, and to perform optical character recognition (OCR) on the captured document or provide a translation service. However, depending on the position and pose of the camera, a distortion may occur in the document obtained based on the image captured by the camera. A rectification technology has been developed to remove this document distortion.

However, when using conventional rectification technology, there is a constraint in that the entire document area must (or should) be secured (e.g., depicted) in the image in order to remove the document distortion from the captured image, and only one rectangular subject (or object) must (or should) exist (e.g., be contained or depicted) in the image. In addition, background information present in the initially captured image may be lost when the distortion is removed from the document image according to the conventional rectification technology.

### SUMMARY

In order to address the above-described challenges, the present disclosure provides a method for training a document image distortion correction model, a document image distortion correction method, and a device (e.g., a system).

The present disclosure may be implemented in various forms, including a method, a device (system), or a computer program stored in a non-transitory computer-readable storage medium.

A method for training a document image distortion correction model according to embodiments of the present disclosure may include receiving a first grid dividing a document area into multiple cells on a first image comprising the document area, based the first grid, generating a second grid representing a state in which a distortion of the first image is corrected, generating a backward map calculating a pixel in the first grid corresponding to each pixel in the second grid, and training a document image distortion correction model to generate the backward map from the first image.

According to embodiments of the present disclosure, a document image distortion correction method may include receiving a first image including a document area, generating a backward map for correcting a distortion of the first image by using a document image distortion correction model, and based on the backward map, generating a second image obtained by correcting the distortion of the first image.

A non-transitory computer-readable recording medium may be provided storing a computer program that, when executed by a computer, causes the computer to perform the method according to embodiments of the present disclosure on a computer.

An information processing system according to embodiments of the present disclosure may include a communication module, a memory, and at least one processor connected to the memory and configured to execute at least one computer-readable program included in the memory, wherein the at least one program comprises instructions for, receiving a first grid dividing a document area into multiple cells on a first image comprising the document area, based on the first grid, generate a second grid representing a state in which a distortion of the first image is corrected, generate a backward map calculating a pixel in the first grid, corresponding to each pixel in the second grid, and train a document image distortion correction model to generate the backward map from the first image.

According to embodiments of the present disclosure, a document image distortion correction model may be trained to output, from an original image, a backward map that may be used to correct the distortion of the image. In this case, a higher-quality image distortion correction may be performed by utilizing the backward map that defines a reverse conversion relationship instead of a forward map that defines a conversion relationship from an input image to an output image in which the distortion is corrected, thereby preventing or reducing a hole phenomenon in which some pixels are not filled in the distortion-corrected image.

According to embodiments of the present disclosure, the distortion of a document may be corrected without being dependent on the form of a document and/or text in the original image. In addition, even if the entire document area is not secured from the input image, the distortion present in the document area may be corrected, and since the background information around the document area is not lost after the distortion correction, a higher-quality distortion-corrected image may be generated.

According to embodiments of the present disclosure, a higher quality image may be generated by post-processing the distortion-corrected image. In addition, by extracting text from the distortion-corrected image by using the backward map and then translating the text, a higher quality translation service may be provided.

The effects of the present disclosure are not limited to the effects described above, and other effects not described above will be clearly understood by those with ordinary knowledge in the art (“persons skilled in the art”) to which the present disclosure pertains from the claims.

### BRIEF DESCRIPTION OF DRAWINGS

Embodiments of the present disclosure will be described with reference to the accompanying drawings, and like reference numerals denote like elements, but are not limited thereto.

FIG. 1 illustrates an example of a method for training a document image distortion correction model according to embodiments of the present disclosure.

FIG. 2 is a block diagram illustrating an internal configuration of an information processing system according to embodiments of the present disclosure.

FIG. 3 is a diagram illustrating an internal configuration of a processor of an information processing system according to embodiments of the present disclosure.

FIG. 4 is a diagram illustrating an example of an internal configuration of a document image distortion correction model according to embodiments of the present disclosure.

FIG. 5 is a diagram illustrating an example of generating a grid on an original image according to embodiments of the present disclosure.

FIG. 6 is a diagram illustrating an example of multiple patches according to embodiments of the present disclosure.

FIG. 7 is a diagram illustrating an example of generating a second grid on the basis of a first grid, according to embodiments of the present disclosure.

FIG. 8 is a diagram illustrating an example of multiple patches according to embodiments of the present disclosure.

FIG. 9 is a diagram illustrating an example of calculating a backward map according to embodiments of the present disclosure.

FIG. 10 is a diagram illustrating an example of a distortion-corrected image according to embodiments of the present disclosure.

FIG. 11 is a diagram illustrating an example of post-processing a generated image according to embodiments of the present disclosure.

FIG. 12 is a flowchart illustrating an example of a training method of a document image distortion correction model according to embodiments of the present disclosure.

FIG. 13 is a flowchart illustrating an example of a document image distortion correction method according to embodiments of the present disclosure.

### DETAILED DESCRIPTION

Hereinafter, the specific content for embodiments of the present disclosure will be described in detail with reference to the attached drawings. However, in the following description, specific descriptions of widely known functions or configurations that may unnecessarily obscure the subject matter of the present disclosure will be omitted.

Throughout the accompanying drawings, identical, similar, or corresponding elements are given the same (or similar) reference numerals. Furthermore, repeated description of the same, similar or corresponding components may be omitted in the following description of embodiments. However, omission of a description of components is not intended to mean exclusion of the components from embodiments.

The advantages and features of the examples described above and methods for achieving the same will be more apparent from the following examples, which will be described in detail with reference to the attached drawings. However, the present disclosure is not limited to the examples described below, and may be implemented in various different forms. The examples are only provided to make the present disclosure complete and to fully inform the skilled person of the scope of the present disclosure.

The terms used in this specification will be briefly described, and the disclosed examples will be specifically described. The terms used in this specification were selected to be as widely used as possible, considering the function in the present disclosure, but may vary depending on the intention of a person skilled in the relevant field, case law, or the emergence of new technology. In addition, in a specific case, there are also terms selected (or created) by the applicant, and in this case, the meaning will be described in detail in the description of the relevant disclosure. Therefore, the terms used in the present disclosure should be defined based on their meanings and the overall content of the present disclosure, rather than merely as names of the terms.

In the present specification, the terms of a singular form may include plural forms unless clearly indicated as the singular in the context. In addition, unless otherwise specified in the context, the term “multiple” includes a singular form. Wherein, in the entire specification, when a part is stated to include a component, this means that other components may be further included, rather than excluding other components, unless otherwise specified.

In addition, the term “module” or “unit” used in the specification indicates a software or hardware component, and the “module” or “unit” performs some functions. However, the “module” or “unit” is not intended to be limited to software or hardware. The “module” or “unit” may be configured to reside in an addressable storage medium or may be configured to drive one or more processors. Therefore, as an example, “modules” or “units” may include at least one component such as software components, object-oriented software components, class components, and task components, processes, functions, properties, procedures, subroutines, segments of program code, drivers, firmware, microcode, circuits, data, databases, data structures, tables, arrays, or variables. Functions of the components and “modules” or “units” may be combined into a smaller number of components and “modules” or “units” or may be further divided into additional components and “modules” or “units” depending on the functions provided inside.

According to embodiments of the present disclosure, a “module” or a “unit” may be implemented by a processor and a memory. The “processor” should be broadly interpreted to include a general-purpose processor, a central processing unit (CPU), a microprocessor, a digital signal processor (DSP), a controller, a microcontroller, a state machine, and the like. In some environments, a “processor” may also refer to an application-specific integrated circuit (ASIC), a programmable logic device (PLD), a field-programmable gate array (FPGA), and the like. The “processor” may indicate a combination of processing devices, such as a combination of a DSP and a microprocessor, a combination of multiple microprocessors, a combination of one or more microprocessors with a DSP core, or a combination of any other such configurations. In addition, the “memory” should be interpreted to include any electronic component capable of storing electronic information. The “memory” may refer to various types of processor-readable media, such as a random access memory (RAM), read-only memory (ROM), a non-volatile random access memory (NVRAM), a programmable read-only memory (PROM), an erasable programmable read-only memory (EPROM), an electrically erasable programmable read-only memory (EEPROM), a flash memory, magnetic or optical data storage devices, and registers. The memory is described to be in electronic communication with the processor if the processor may read information from the memory and/or write information into the memory. The memory integrated into the processor is in electronic communication with the processor.

In the present disclosure, a “system” may include at least one of a server device and/or a cloud device, but is not limited thereto. For example, the system may be configured as one or more server devices. As another example, the system may be configured as one or more cloud devices. As another example, the system may be configured and operated with a server device and a cloud device.

In the present disclosure, a “display” may indicate any display device associated with a computing device, for example, any display device that may display any information/data controlled by or provided from the computing device.

In the present disclosure, “each of the multiple A” or “respective multiple A” may indicate each of all the components included in the multiple A, or each of some of the components included in the multiple A.

In the present disclosure, a “machine learning model” may include any model used to infer an answer to a given input. According to embodiments, the machine learning model may include an artificial neural network model including an input layer, multiple hidden layers, and an output layer. Here, each layer may include multiple nodes. In this disclosure, each of the multiple machine learning models is described as a separate machine learning model, but is not limited thereto, and some or all of the multiple machine learning models may be implemented as a single machine learning model. In addition, a single machine learning model may include multiple machine learning models. In this disclosure, the terms “machine learning model” and “artificial neural network model” may be used interchangeably to represent the same or similar models.

In the present disclosure, the “document image” may include an image generated by photographing or scanning a printed document, and an image related to an electronic document (e.g., an electronic receipt, an electronic business card, an electronic identification card, etc.) generated by a program.

In the present disclosure, a “document area” may refer to an area in a document image that includes text and is subject to character recognition or translation. In addition, in the present disclosure, a “background area” may indicate the remaining area excluding (or other than) the document area in the document image.

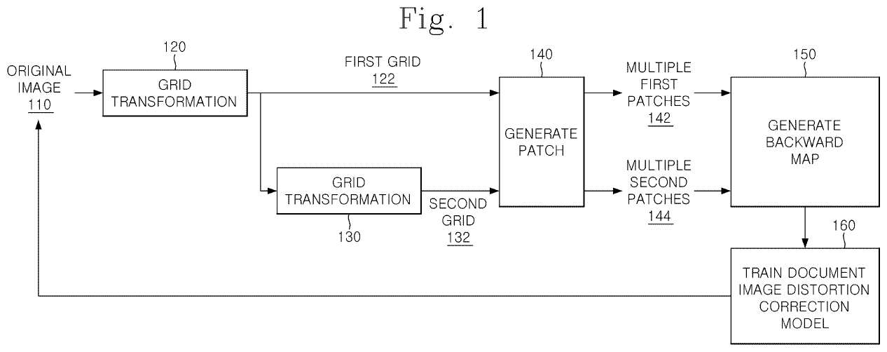

FIG. 1 illustrates an example of a method for training a document image distortion correction model according to embodiments of the present disclosure. In embodiments, a grid may be generated on an original image 110 including a document area. Specifically, a first grid 122 configured to divide the document area of the original image 110 into multiple cells may be generated. Here, a slope of a horizontal line and a slope of a vertical line of the first grid 122 may be determined based on a direction of the text included in the document area. The first grid 122 generated in this way may approximately express a distortion such as rotation, warping, or wrinkling of the document area included in the original image 110 in a patch level. For example, the first grid 122 may include cells divided into 10×10 grids, but is not limited thereto. The generation 120 of the first grid 122 may be performed using an image editing application or an appropriate grid generation algorithm.

In addition, the generated first grid 122 may be converted to generate a second grid 132 (130). Here, the second grid 132 may express a state where a distortion of the document area expressed by the first grid 122 is corrected in a patch level. The second grid 132 may be generated to include multiple cells in a horizontal rectangular shape, based on an average of coordinate values of edge points of the first grid 122 and an average of the multiple cell intervals.

In embodiments, multiple patches may be generated from each of the first grid 122 and the second grid 132 (140). Specifically, multiple first patches representing multiple cells divided by the first grid 122 may be generated. Here, the multiple first patches 142 may include multiple triangular patches generated by applying Delaunay triangulation to multiple points included in the first grid 122 and four vertices of the original image 110. Similarly, multiple second patches 144 representing multiple cells divided by the second grid 132 may be generated. Here, the multiple second patches 144 may include multiple triangular patches generated by applying Delaunay triangulation to multiple points included in the second grid 132 and four vertices of the image obtained by correcting the distortion of the original image 110.

In embodiments, a backward map may be generated based on the multiple first patches 142 and the multiple second patches 144 (150). Specifically, a transformation matrix defining a conversion relationship from each of the multiple second patches to the corresponding first patch may be calculated. As described above, multiple transformation matrices may be combined to generate a backward map for the entire image. Accordingly, the backward map may calculate a pixel in the first grid 122 of the image before distortion correction, corresponding to each pixel in the second grid 132 of the image after distortion correction.

In embodiments, the document image distortion correction model may be trained to generate a backward map 160 from the original image 110 (160). That is, the document image distortion correction model may be trained to produce a backward map capable of correcting a distortion on a corresponding image in response to an input image, using, as the training data, a pair of the original image 110 and the backward map 160 associated with the original image. Here, the document image distortion correction model may be an encoder-decoder-based deep learning model capable of learning to output a backward map for distortion correction of an image, based on an input image, but is not limited thereto.

The document image distortion correction model trained by this configuration may generate a backward map used for correcting the distortion of the document area from the input image. In addition, a distortion-corrected output image may be generated by applying the backward map to the input image. The output image with corrected distortion may be used for subsequent processes such as optical character recognition (OCR) or translation.

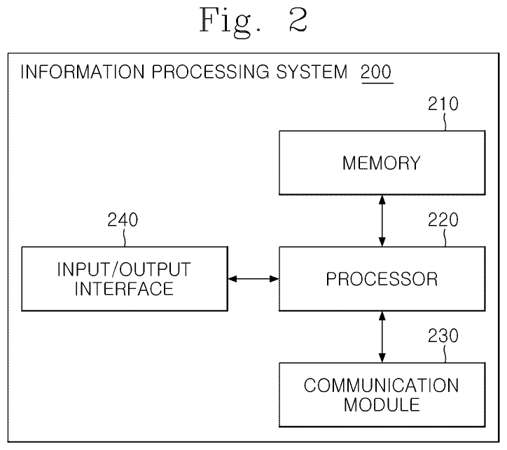

FIG. 2 is a block diagram illustrating an internal configuration of an information processing system 200 according to embodiments of the present disclosure. The information processing system 200 may include a memory 210, a processor 220, a communication module 230, and/or an input/output interface 240. The information processing system 200 may be configured to communicate information and/or data with an external system through a network by using the communication module 230.

The memory 210 may include any non-transitory computer-readable recording medium. According to embodiments, the memory 210 may include a non-volatile mass storage device (permanent mass storage device) such as a read only memory (ROM), a disk drive, a solid state drive (SSD), a flash memory, and the like. As another example, a non-volatile mass storage device such as a ROM, an SSD, a flash memory, or a disk drive may be included in the information processing system 200 as a separate permanent storage device distinct from the memory. In addition, the memory 210 may store an operating system and at least one program code (e.g., a code for executing document distortion correction installed and operated on the information processing system 200).

These software components may be loaded from a computer-readable recording medium separate from the memory 210. Such a separate non-transitory computer-readable recording medium may include a recording medium directly connected to the information processing system 200, for example, a floppy drive, a disk, a tape, a DVD/CD-ROM drive, a memory card, and the like. As another example, the software components may be loaded into the memory 210 through the communication module 230. For example, at least one program may be loaded into the memory 210, based on a computer program (e.g., a program for training a document distortion correction model, a program for executing document distortion correction, and the like) that is provided through the communication module 230 by a file distribution system that distributes installation files of the application or by developers.

The processor 220 may be configured to process instructions of the computer program by performing basic arithmetic, logic, and input/output operations. The instructions may be provided to a user terminal (not shown) or another external system by the memory 210 or the communication module 230. For example, the processor 220 may generate, on the basis of the first grid, the second grid representing a state in which a distortion of a first image is corrected, generate a backward map for calculating a pixel in the first grid corresponding to each pixel in the second grid, and train the document image distortion correction model to generate a backward map from the first image. In addition, the processor 220 may generate a second image obtained by correcting the distortion of the first image, by using the backward map generated by the document image distortion correction model, on the basis of the first image. In addition, the processor 220 of the information processing system 200 may be configured to manage, process, and/or store information and/or data received from multiple user terminals and/or multiple external systems.

The communication module 230 may provide a configuration or function for a user terminal (not shown) and the information processing system 200 to communicate with each other through a network, and may provide a configuration or function for the information processing system 200 to communicate with an external system (e.g., a separate cloud system, or the like). For example, control signals, instructions, data, and the like, provided under the control of the processor 220 of the information processing system 200 may be transmitted to the user terminal and/or the external system through a communication module of the user terminal and/or the external system via the communication module 230 and the network. For example, the information processing system 200 may transmit the image with corrected document distortion to the user terminal through the communication module 230.

In addition, the input/output interface 240 of the information processing system 200 may be a means for interfacing with a device (not shown) for input or output, which may be connected to the information processing system 200 or included in the information processing system 200. Although the input/output interface 240 is illustrated as a separate element from the processor 220 in FIG. 2, the input/output interface 240 is not limited thereto and may be configured to be included in the processor 220. The information processing system 200 may include more or fewer components than the components shown in FIG. 2. However, there is no need to clearly illustrate most known components.

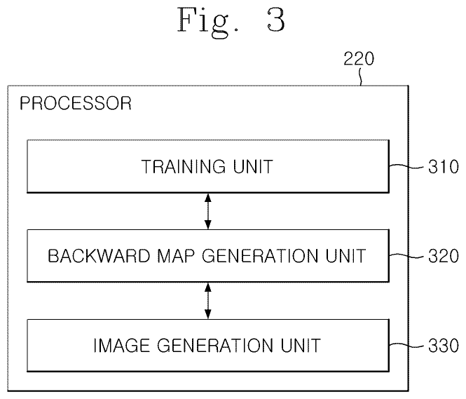

FIG. 3 is a diagram illustrating an internal configuration of the processor 220 of the information processing system 200 according to embodiments of the present disclosure. According to embodiments, the processor 220 may include a training unit 310, a backward map generation unit 320, and/or an image generation unit 330. The internal configuration of the processor 220 of the information processing system illustrated in FIG. 3 is only an example and may be implemented differently. For example, at least some components of the processor 220 may be omitted, or other components may be added, and at least some of the operations or processes performed by the processor 220 may be performed by a processor of a user terminal that is communicatively connected to the information processing system 200.

The training unit 310 may train the document image distortion correction model by using learning data (may also be referred to herein as training data) including one or more document images and one or more backward maps corresponding thereto. Specifically, the processor 220 may receive the first grid configured to divide the document area on the first image including the document area into multiple cells. In this case, the training unit 310 may generate the second grid representing a state in which the distortion of the first image is corrected, on the basis of the first grid. Specifically, the training unit 310 may generate the second grid including multiple cells in a horizontal rectangular shape, on the basis of an average of coordinate values of edge points of the first grid and an average of multiple cell intervals.

In embodiments, the training unit 310 may generate multiple first patches representing multiple cells divided by the first grid. Here, the multiple first patches may include multiple triangle patches generated by applying Delaunay triangulation to multiple points included in the first grid and four vertices of the first image. Similarly, the training unit 310 may generate multiple second patches representing multiple cells divided by the second grid. The multiple second patches may include multiple triangle patches generated by applying Delaunay triangulation to multiple points included in the second grid and four vertices of the second image.

In embodiments, the training unit 310 may generate a backward map for calculating a pixel in the first grid corresponding to each pixel in the second grid. Specifically, the training unit 310 may calculate a transformation matrix from each of the multiple second patches to each of the multiple first patches. In addition, the training unit 310 may generate a backward map, on the basis of the transformation matrix. Here, the transformation matrix may include an affine transformation matrix, but is not limited thereto.

In embodiments, the training unit 310 may train the document image distortion correction model, on the basis of the first image and the backward map generated therefrom. Specifically, the training unit 310 may train the document image distortion correction model to generate a backward map from the first image. Here, the document image distortion correction model may be an encoder-decoder-based deep learning model capable of learning to output a backward map, on the basis of the first image.

The backward map generation unit 320 may generate a backward map, on the basis of the input image. Here, the backward map generation unit 320 may include the document image distortion correction model trained by the training unit 310. Alternatively, the backward map generation unit 320 may transmit the image input to a document image distortion correction model existing outside the processor 220 and receive a backward map generated from the document image distortion correction model. The backward map generation unit 320 may transmit the generated backward map to the image generation unit 330.

The image generation unit 330 may generate an image obtained by correcting the distortion of the input image by using the backward map received from the backward map generation unit 320. In addition, the image generation unit 330 may remove a blank area generated due to the distortion correction from the distortion-corrected image. In addition, the image generation unit 330 may extract text from the distortion-corrected image by using an appropriate OCR algorithm. In addition, the image generation unit 330 may translate the extracted text into text of a different language from the language of the text by using an appropriate translation algorithm.

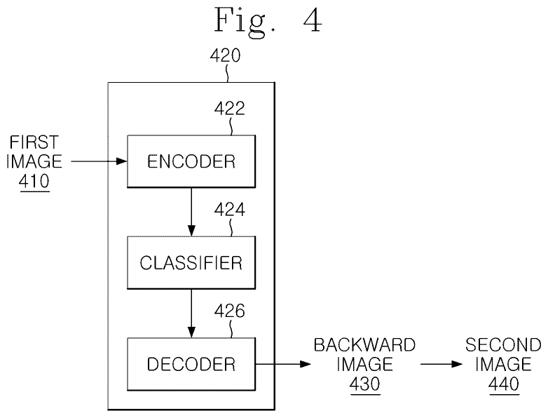

FIG. 4 is a diagram illustrating an example of an internal configuration of a document image distortion correction model 420 according to embodiments of the present disclosure. In embodiments, the document image distortion correction model 420 may receive a first image 410 including a background area and a document area. Here, the document image distortion correction model 420 may include an encoder 422, a classifier 424, and/or a decoder 426. For example, the document image distortion correction model 420 may be an encoder-decoder-based deep learning model based on a U-Net, but is not limited thereto.

In embodiments, the document image distortion correction model 420 may be trained to output a backward map by receiving the original image as an input. In this case, the document image distortion correction model 420 may encode the first image 410 by using the encoder 422. Here, the encoder 422 may be configured as a transformer-based model, but is not limited thereto. In addition, the document image distortion correction model 420 may output a backward map 430 for the first image 410 by using the decoder 426. The generated backward map 430 may be used to generate a second image 440 obtained by correcting the distortion of the first image 410. According to embodiments, the second image 440 may be obtained by applying the transformation(s) represented by the backward map 430 to the first image 410.

In embodiments, the document image distortion correction model 420 may determine whether or not there is a distortion in the first image 410 by using the classifier 424. Specifically, the document image distortion correction model 420 may calculate a distortion score of the first image 410 by using the classifier 424. Here, the distortion score may be normalized to have a value of 0 to 1, and a distortion score close to 1 may indicate that the image is distorted.

In embodiments, the document image distortion correction model 420 may be pre-trained (or trained) to output one of a backward map or an input image, based on the calculated distortion score. Specifically, the document image distortion correction model 420 may be trained to output the first image 410 in (or based on, or in response to) the case where the classifier 424 produces a distortion score lower than a preconfigured (or alternatively, given) threshold (e.g., 0.5). On the other hand, the document image distortion correction model 420 may be trained to output the backward map 430 for the first image 410 by using the decoder 426 in (or based on, or in response to) the case that the classifier 424 produces a distortion score equal to or greater than a preconfigured (or alternatively, given) threshold (e.g., 0.5).

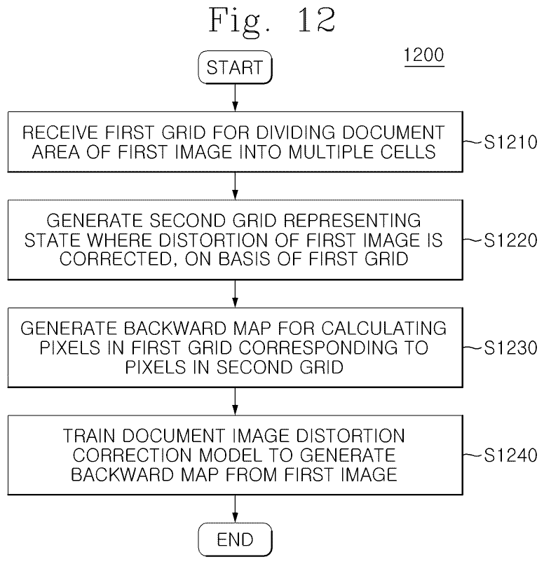

In embodiments, the document image distortion correction model 420 may learn a pair of an original image and a backward map as a ground truth data pair or a training data pair. Here, the original image of the training data pair may include not only an image with document distortion but also an image without document distortion. Accordingly, the document image distortion correction model 420 may infer a backward map for an image without document distortion, and the classifier 424 may be trained using an image without document distortion. In this case, for an image without document distortion, an identity backward map using positions of pixel values of the original image may be used. In addition, for augmentation of the training data, the original image and an image in which a grid is displayed may be rotated and flipped to increase the amount of training data. According to embodiments, the document image distortion correction model 420 may be iteratively trained using a training dataset. The training dataset may include a plurality of pairs of an original image and a corresponding backward map. The each of the backward maps may be generated according to the process described in connection with FIG. 12 below with respect to an original image (or first image) corresponding to the backward map. The training of the document image distortion correction model 420 may involve inputting an original image of a given pair into the document image distortion correction model 420 to obtain an output backward map. The output backward map may be compared to the backward map of the pair (e.g., the backward map corresponding to the original image input into the document image distortion correction model 420) to determine a difference (or distance) between the output backward map and the corresponding backward map. At least one parameter (e.g., at least one bias or weight) of the document image distortion correction model 420 may be adjusted according to the determined difference (or distance), for example, to minimize (or reduce) a loss function. The training of the document image distortion correction model 420 may be repeated using different pairs of original images and backward maps included in the training dataset. For example, the training of the document image distortion correction model 420 may be repeated until the difference (or distance) between the output backward maps and the corresponding backward maps falls below a threshold value.

In embodiments, an L1 loss (or a mean absolute loss (MAE) loss) function may be used for the training of the decoder 426 configured to output a backward map. In addition, a binary cross entropy (BCE) loss function may be used for the training of the classifier 424.

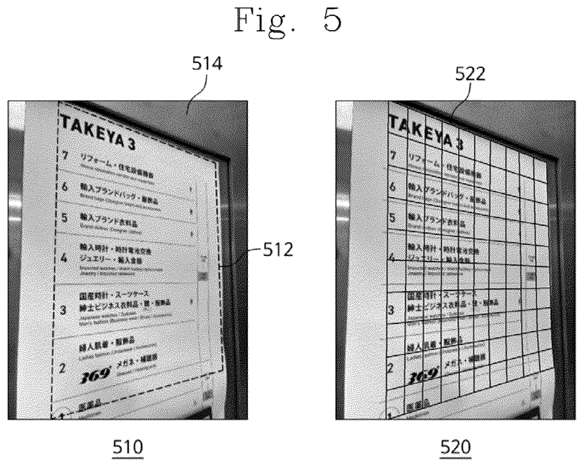

FIG. 5 is a diagram illustrating an example of generating a grid 522 on an original image according to embodiments of the present disclosure. A first example 510 shows an example of an original image. Here, the original image may include a document area 512 and a background area 514. In the case where the original image includes multiple document areas, only one of the multiple document areas may be determined as the document area 512 to be the subject of distortion correction, and the other document areas may be determined as background areas 514. In addition, a second example 520 shows an example of displaying the grid 522 on the original image.

In embodiments, the grid 522 may be generated to cover the document area 512. Specifically, a main subject may be determined in the original image. For example, in the first example 510, a white poster may be determined as the main subject. In this case, an area with a maximum (or largest) size for text that is not cut off among the text inside the main subject may be determined as an area (e.g., the document area 512) of the grid 522.

In embodiments, the grid 522 may include multiple cells. For example, the grid 522 may include 10×10 cells by drawing and connecting 11×11 points. In this case, a slope of horizontal lines of the grid 522 and a slope of vertical lines of the grid 522 may be determined to correspond to a direction of text, a direction of lines, and the like, included in the document area 512, in order to represent a form of document distortion. Accordingly, the distortion such as rotation, warping, and/or wrinkling of the document may be expressed in a patch level through the grid 522.

Although the grid 522 is illustrated as 10×10 in FIG. 5, the present disclosure is not limited thereto. For example, the number of cells in the grid may be determined based on the time and cost required (or used) to generate the grid. By simplifying the document area 512 through the grid 522, a document distortion correction training dataset may be constructed at a reasonable cost.

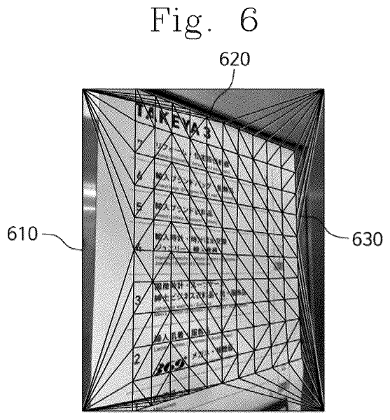

FIG. 6 is a diagram illustrating an example of multiple patches 630 according to embodiments of the present disclosure. In embodiments, multiple patches 630 may be generated, based on multiple points included in a grid 620 displayed on an original image 610. Specifically, the multiple patches 630 may include multiple triangular patches generated by applying Delaunay triangulation to multiple points included in the first grid 620 and four vertices of the original image 610. For example, in case that the grid 620 includes 11×11 points, Delaunay triangulation may be performed using a total of 125 points obtained by adding 4 vertices of the original image 610 (e.g., the four corners of the document area). Here, by using the four vertices of the original image 610, distortion correction may be performed for the entire original image 610, including not only the inside of the grid 620 but also the outside area. In addition, distortion may be corrected more smoothly through the triangular patches.

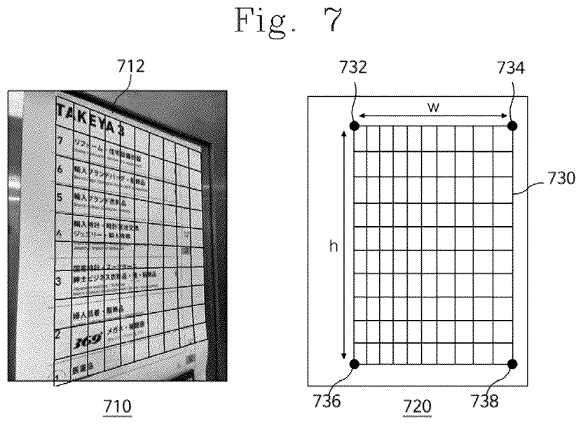

FIG. 7 is a diagram illustrating an example of generating a second grid 730 on the basis of a first grid 712, according to embodiments of the present disclosure. A first example 710 illustrates an example in which a first grid 712 is displayed on a first image (or, an original image) as described above with reference to FIG. 5. In addition, a second example 720 illustrates an example in which a second grid 730 is displayed on a second image (or a target image).

In embodiments, the second grid 730, which represents a state in which distortion of the first image is corrected, may be generated on the basis of the first grid 712. Specifically, the second grid 730 may be generated in a horizontal right angle form (e.g., the second grid 730 including multiple cells in a horizontal rectangular shape), on the basis of an average of coordinate values of edge points of the first grid 712 and an average of intervals of multiple cells.

For example, the width w of the second grid 730 may be an average of a first distance between the x-coordinate of the upper-left vertex (e.g., a vertex 732) and the x-coordinate of the upper-right vertex of the first grid 712 (e.g., a vertex 734) and a second distance between the x-coordinate of the lower-left vertex (e.g., a vertex 736) and the x-coordinate of the lower-right vertex of the first grid 712 (e.g., a vertex 738) (e.g., a first average of the first distance and the second distance). Similarly, the height h of the second grid 730 may be an average of a third distance between the y-coordinate of the upper-left vertex (e.g., the vertex 732) and the y-coordinate of the lower-left vertex of the first grid 712 (e.g., the vertex 736) and a fourth distance between the y-coordinate of the upper-right vertex (e.g., the vertex 734) and the y-coordinate of the lower-right vertex of the first grid 712 (e.g., the vertex 738) (e.g., a second average of the third distance and the fourth distance). For example, an x-direction may be perpendicular to a y-direction, an x-coordinate may represent a position in the x-direction, and a y-coordinate may represent a position in the y-direction. Also, the vertices may refer to corners of the first grid 712 (e.g., the document area).

In addition, the coordinates of the vertices 732, 734, 736, and 738 of the second grid 730 may be determined on the basis of the first grid 712. Specifically, the x-coordinate of the upper-left vertex 732 of the second grid 730 may be an average of the x-coordinates of the left-side vertices of the first grid 712 (e.g., an average of the x-coordinates of all of the left-most vertices of the first grid 712). Furthermore, the y-coordinate of the upper-left vertex 732 of the second grid 730 may be an average of the y-coordinates of the upper-side vertices of the first grid 712 (e.g., an average of the y-coordinates of all of the top-most vertices of the first grid 712). After the coordinates of the upper-left vertex 732 of the second grid 730 are calculated, the coordinates of the remaining vertices 734, 736, and 738 may be calculated using the width w and the height h of the second grid 730, which have been calculated. According to embodiments, the width w and the height h of the second grid 730 are calculated based on the x- and y-coordinates of the first grid 712, the upper-left vertex 732 of the second grid 730 is calculated according to the left- and right-side vertices of the first grid 712, and the remaining vertices 734, 736, and 738 of the second grid 730 are calculated based on the width w and height h distances from the upper-left vertex 732 of the second grid 730. For example, the upper-right vertex 734 may have the same y-coordinate (or a similar y-coordinate) as the upper-left vertex 732 and have an x-coordinate that is the sum of the width w and the x-coordinate of the upper-left vertex 732. The lower-left vertex 736 may have the same x-coordinate (or a similar x-coordinate) as the upper-left vertex 732 and have a y-coordinate that is the sum of the height h and the y-coordinate of the upper-left vertex 732. The lower-right vertex 738 may have an x-coordinate that is the sum of the width w and the x-coordinate of the upper-left vertex 732, and a y-coordinate that is the sum of the height h and the y-coordinate of the upper-left vertex 732.

In addition, multiple cell intervals of the second grid 730 may be determined on the basis of multiple cell intervals of the first grid 712. Specifically, an interval of the horizontal lines of the second grid 730 may be calculated according to an interval ratio of the horizontal lines of the first grid 712. Similarly, an interval of the vertical lines of the second grid 730 may be calculated according to an interval ratio of the vertical lines of the first grid 712.

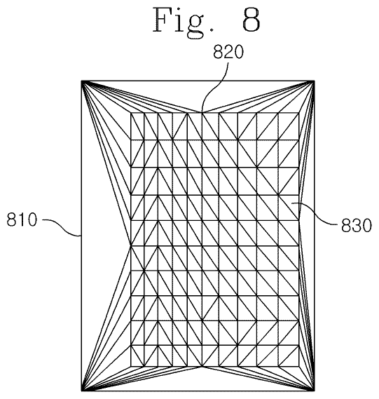

FIG. 8 is a diagram illustrating an example of multiple patches 830 according to embodiments of the present disclosure. In embodiments, multiple patches 830 may be generated, based on multiple points included in a second grid 820 displayed on a target image 810. Specifically, the multiple patches 830 may include multiple triangular patches generated by applying Delaunay triangulation to multiple points included in the second grid 820 and four vertices of the target image 810. For example, in case that the second grid 820 includes 11×11 points, Delaunay triangulation may be performed using a total of 125 points obtained by adding 4 vertices of the target image 810. Here, by using the four vertices of the target image 810, distortion correction may be performed for the entire target image 810, including not only the inside of the second grid 820 but also the outside area. In addition, distortion may be corrected more smoothly through the triangular patches.

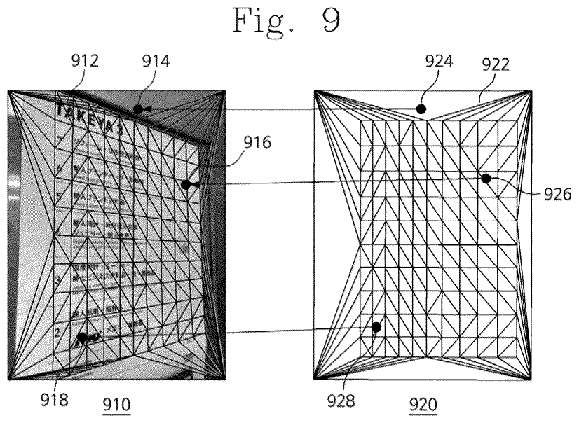

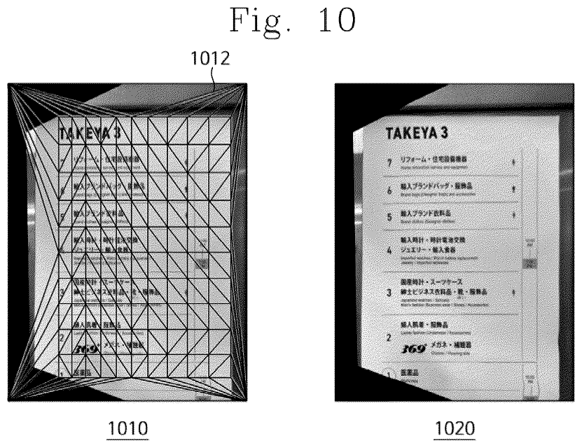

FIG. 9 is a diagram illustrating an example of calculating a backward map according to embodiments of the present disclosure and FIG. 10 is a diagram illustrating an example of a distortion-corrected image according to embodiments of the present disclosure. A first example 910 shows an example in which multiple first patches 912 for the first grid are generated, as described above with reference to FIG. 6. In addition, a second example 920 shows an example in which multiple second patches 922 for the second grid are generated, as described above with reference to FIG. 8.

In embodiments, a backward map for calculating a pixel in the first grid corresponding to each pixel in the second grid may be generated. Specifically, a transformation matrix from each of the multiple second patches 922 to each of the multiple first patches 912 may be calculated. For example, a first transformation matrix, by which a first pixel 924 of the multiple second patches 922 is converted to a first pixel 914 of the multiple first patches 912, may be calculated. Similarly, a second transformation matrix and a third transformation matrix, by which a second pixel 926 and a third pixel 928 of the multiple second patches 922 are converted into a second pixel 916 and a third pixel 918 of the multiple first patches 912, respectively, may be calculated.

In embodiments, multiple transformation matrices generated by the above-described method may be combined to generate a backward map. That is, a backward map for the entire target image may be generated by synthesizing the backward maps by which the multiple second patches 922 are converted to the multiple first patches 912, respectively. In this manner, by using the backward map to fill each pixel of the target image, no hole occurs in any of the pixels in the target image (or fewer holes occur in pixels in the target image), thereby enabling high-quality images to be generated.

Referring to FIG. 10, a third example 1010 illustrates an example of an image in which values of all pixels in multiple second patches 1012 are generated using a backward map for the entire target image. In addition, a fourth example 1020 is an example of an image output. As shown in FIG. 10, an image obtained by correcting the distortion of the original image may be output. In this case, the distortion-corrected image may retain not only the document area of the original image but also the background area. In addition, the distortion of not only the document area but also the background area may be corrected.

According to this configuration, the distortion of a document may be corrected without being dependent on the form of a document and/or text in the original image. In addition, even if the entire document area is not secured, the distortion may be corrected, and since the background information is not lost, a higher-quality distortion-corrected image may be generated.

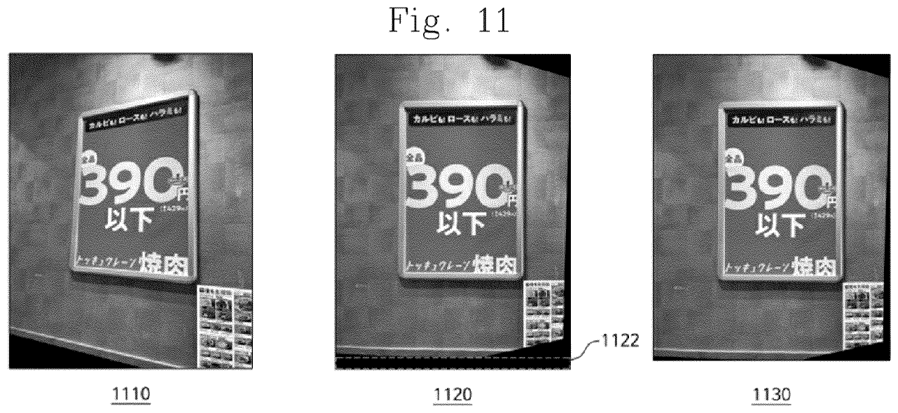

FIG. 11 is a diagram illustrating an example of post-processing a generated image according to embodiments of the present disclosure. In embodiments, a second image 1120 with corrected distortion may be generated from a first image 1110 input by a user. Specifically, a processor (e.g., 220 in FIG. 2) may receive the first image including a document area. Here, the document area may indicate a text area included in the main subject. In addition, the processor may generate a backward map for correcting the distortion of the first image 1110 by using a pretrained (or trained) document image distortion correction model. Thereafter, the processor may generate the second image 1120 obtained by correcting the distortion of the first image 1110, on the basis of the generated backward map.

In embodiments, the second image 1120 may include an empty area 1122. Such an empty area 1122 may be generated at the edge of an image while correcting the distortion of the first image 1120. In this case, the processor may generate a third image 1130 by cropping the empty area 1122. The process of cropping the empty area 1122 may be performed as long as the background information of the first image 1110 is not damaged. According to embodiments, the process of cropping the empty area 1122 may include segmenting pixels of the empty area 1122 relative to the remainder of the second image 1120, and editing the second image 1120 to remove (e.g., delete) the segmented pixels of the empty area 1122.

In embodiments, the processor may extract text included in the second image 1120 or the third image 1130 by using an appropriate OCR method. In addition, the processor may translate the extracted text into text in a language different from the language of the text, by using an appropriate translation method. For example, the processor may generate an image that translates Japanese text included in the second image 1120 or the third image 1130 into Korean text. According to embodiments, the processor may extract the text by segmenting pixels of the second image 1120 or the third image 1120 (e.g., according to pixel color, intensity, etc.) and classify at least some groups of the segmented pixels as the extracted text.

By this configuration, a higher quality image may be generated by post-processing the distortion-corrected image. In addition, by extracting and translating the text from the distortion-corrected image, a higher quality translation service may be provided.

FIG. 12 is a flowchart illustrating an example of a training method 1200 of a document image distortion correction model according to embodiments of the present disclosure. In embodiments, the training method 1200 of a document image distortion correction model may be performed by at least one processor (e.g., the processor 220). The training method 1200 may begin with the processor receiving a first grid for dividing a document area of a first image into multiple cells (S1210). Here, the slope of the horizontal line and the slope of the vertical line of the first grid may be determined based on the direction of the text in the document area.

Thereafter, the processor may generate a second grid representing a state in which the distortion of the first image is corrected, on the basis of the first grid (S1220). Specifically, the processor may generate multiple first patches representing multiple cells divided by the first grid. Furthermore, the processor may generate the second grid including multiple cells in a horizontal rectangular shape, on the basis of an average of coordinate values of edge points of the first grid and an average of multiple cell intervals. Here, the multiple first patches may include multiple triangle patches generated by applying Delaunay triangulation to multiple points included in the first grid and four vertices of the first image.

Subsequently, the processor may generate a backward map for calculating a pixel in the first grid corresponding to each pixel in the second grid (S1230). Specifically, a transformation matrix from each of the multiple second patches to each of the multiple first patches may be calculated. In addition, the processor may generate a backward map, on the basis of the transformation matrix.

Thereafter, the processor may train the document image distortion correction model to generate a backward map from the first image (S1240). Here, the document image distortion correction model may be an encoder-decoder-based deep learning model capable of learning to output a backward map, on the basis of the first image.

In embodiments, the processor may generate multiple second patches representing multiple cells divided by the second grid. Here, the multiple second patches may include multiple triangle patches generated by applying Delaunay triangulation to multiple points included in the second grid and four vertices of the second image.

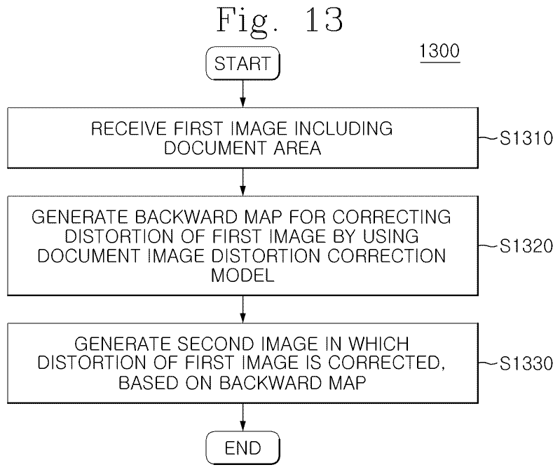

FIG. 13 is a flowchart illustrating an example of a document image distortion correction method 1300 according to embodiments of the present disclosure. In embodiments, the document image distortion correction method 1300 may be performed by at least one processor (e.g., the processor 220). The document image distortion correction method 1300 may begin with a processor receiving a first image including a document area (S1310). In this case, in case that the first image includes multiple document areas, the processor may determine one of the multiple document areas as a document area to be subject to distortion correction. In addition, the processor may determine the remaining document area of the first image as a background area.

After that, the processor may generate a backward map for correcting the distortion of the first image by using the document image distortion correction model (S1320). According to embodiments, the processor may obtain the backward map may applying the document image distortion correction model to the first image (e.g., inputting the first image into the document image distortion correction model). Here, the document image distortion correction model may be a machine learning model trained based on a first grid for dividing a document area in the input image into multiple cells, a second grid representing a state of correcting the distortion of the first image generated based on the first grid, and a backward map for calculating a pixel in the first grid corresponding to each pixel in the second grid.

Thereafter, the processor may generate a second image obtained by correcting the distortion of the first image, on the basis of the backward map (S1330). In addition, the processor may remove an empty area of the second image. In addition, the processor may extract text from the document area of the generated second image. After that, the processor may translate the extracted text into text in a different language from the language of the text.

In embodiments, the backward map may be a transformation matrix from each of the multiple second patches generated from the second grid to each of the multiple first patches generated from the first grid. In this case, the multiple first patches may include multiple triangle patches generated by applying Delaunay triangulation to multiple points included in the first grid and four vertices of the first image. Furthermore, the multiple second patches may include multiple triangle patches generated by applying Delaunay triangulation to multiple points included in the second grid and four vertices of the second image.

In embodiments, the document image distortion correction model may include a classifier configured to determine whether or not there is a distortion in the input image. Here, the classifier may calculate a distortion score of the first image, and the document image distortion correction model may be pre-trained (or trained) to output one of the backward map or the first image, on the basis of the calculated distortion score.

The method described above may be provided as a computer program stored on a non-transitory computer-readable recording medium for execution on a computer. The medium may continuously store a computer-executable program or temporarily store the computer-executable program for execution or download. Furthermore, the medium may be various recording means or storage means in a form of single hardware or a combination of several hardware, may be not limited to a medium directly connected to any computer system, and may exist on a network while being dispersed. An example of the recording medium may be one configured to store program instructions, including magnetic media such as a hard disk, a floppy disk and a magnetic tape, optical media such as CD-ROM and a DVD, magneto optical media such as a floptical disk, ROM, RAM, and flash memory. Furthermore, other examples of the recording medium may include an app store in which apps are distributed, a site in which other various pieces of software are supplied or distributed, and recording media and/or storage media managed in a server or the like.

The methods, operations, or techniques of the present disclosure may be implemented by various means. For example, these techniques may be implemented in hardware, firmware, software, or a combination thereof. Those skilled in the art will appreciate that the various example logical blocks, modules, circuits, and algorithm operations described in conjunction with the disclosure herein may be implemented in electronic hardware, computer software, or a combination thereof. To clearly explain the interchangeability of hardware and software, various example components, blocks, modules, circuits, and operations have been generally described above in terms of their functions. Whether such a function is implemented as hardware or as software depends on a specific application and design requirements (or configurations) imposed on the entire system. Those skilled in the art may implement the described functions in various ways for each specific application, but such implementations should not be construed to depart from the scope of the present disclosure.

In a hardware implementation, the processing units used to perform the techniques may be implemented in one or more application-specific integrated circuits (ASICs), digital signal processors (DSPs), graphics processing units (GPUs), digital signal processing devices (DSPDs), programmable logic devices (PLDs), field-programmable gate arrays (FPGAs), processors, controllers, microcontrollers, microprocessors, electronic devices, other electronic units designed to perform the functions described in the present disclosure, computers, or combinations thereof.

Therefore, the various example logical blocks, modules, and circuits described in conjunction with the present disclosure may be implemented or performed by a general-purpose processor, a DSP, an ASIC, an FPGA or other programmable logic devices, discrete gates or transistor logics, discrete hardware components, or any combination of the above designed to perform the functions described herein. The general-purpose processor may be a microprocessor, but alternatively, the processor may be any processor, controller, microcontroller, or state machine. The processor may also be implemented as a combination of computing devices, for example, a combination of a DSP and a microprocessor, multiple microprocessors, one or more microprocessors in conjunction with a DSP core, or any other configuration.

In the case of a firmware and/or software implementation, the techniques may be implemented as instructions stored on a non-transitory computer-readable medium such as a random access memory (RAM), a read-only memory (ROM), a non-volatile random access memory (NVRAM), a programmable read-only memory (PROM), an erasable programmable read-only memory (EPROM), an electrically erasable programmable read-only memory (EEPROM), a flash memory, a compact disc (CD), or a magnetic or optical data storage device. The instructions may be executable by one or more processors and may cause the processor(s) to perform certain aspects of the functions described in the present disclosure.

When implemented in software, the techniques may be stored on or transmitted through a non-transitory computer-readable medium as one or more instructions or code. The non-transitory computer-readable media include both computer storage media and communication media including any medium that facilitates the transmission of a computer program from one location to another. The storage media may be any available media accessible by a computer. As a non-limiting example, these computer-readable media may include, but are not limited to, a RAM, a ROM, an EEPROM, a CD-ROM, or other optical disk storage, a magnetic disk storage, or other magnetic storage devices, or any other medium that may be used to transmit or store desired program code in the form of instructions or data structures and may be accessed by a computer. In addition, the arbitrary access is appropriately performed in a non-transitory computer-readable medium.

For example, when software is transmitted from a website, server, or other remote source using a coaxial cable, an optical fiber cable, a wire, a digital subscriber line (DSL), or wireless technologies such as infrared, radio, and microwaves, the coaxial cable, the optical fiber cable, the wire, the digital subscriber line, and the wireless technologies such as infrared, radio, and microwaves are included within the definition of the medium. In the present disclosure, the term “disk” and “disc” are used to include a CD, a laser disc, an optical disc, a DVD (digital versatile disc), a floppy disc, and a Blu-ray disc, where the “disks” generally reproduce data magnetically, and the “discs” reproduce data optically using a laser. The above combinations should also be included in the scope of computer-readable media.

The software module may also reside in a RAM memory, a flash memory, a ROM memory, an EPROM memory, an EEPROM memory, registers, a hard disk, a portable disk, a CD-ROM, or any other form of storage medium known. The storage medium may be connected to the processor so that the processor may read information from the storage medium or write information to the storage medium. Alternatively, the storage medium may be integrated with the processor. The processor and the storage medium may also be present within the ASIC. The ASIC may also exist inside the user terminal. Alternatively, the processor and the storage medium may exist as individual components in the user terminal.

Although the examples described above have been described as utilizing aspects of the disclosed subject matter in one or more standalone computer systems, the present disclosure is not limited thereto, and may be implemented in conjunction with any computing environment, such as a network or a distributed computing environment. Furthermore, in the present disclosure, aspects of the subject matter may be implemented in multiple processing chips or devices, and storage may also be similarly affected over multiple devices. Such devices may include PCs, network servers, and portable devices.

Conventional devices and methods for correcting image distortion require (or are based on) capture of an entire document area in an image and only one rectangular subject (e.g., only one document or document area) to be present in the image. Also, background information separate from the document area in the image is lost when the image distortion correction is performed according to the conventional devices and methods. Additionally, the conventional devices and methods involve forward mapping from a distorted image to a distortion-corrected image, and as a result, suffer from a hole phenomenon in which some pixels are not filled in the distortion-corrected image. Accordingly, the conventional devices and methods result in image distortion correction of insufficient quality and that is insufficiently robust to implementation in different use cases.

However, according to embodiments, improved devices and methods are provided for performing image distortion correction. For example, the improved devices and methods may generate a backward map for use in correcting image distortion. Also, the improved devices and methods may be performed without capture of an entire document area in an image, with multiple rectangular subjects (e.g., documents or document areas) present in the image, and without loss of background information separate from the document area in the image. According to the improved devices and methods overcome the deficiencies of the conventional devices and methods to at least improve the quality of image distortion correction and/or provide image distortion correction that is more robust to implementation in different use cases.

According to embodiments, operations described herein as being performed by the information processing system 200, the processor 220, the communication module 230, the input/output interface 240, the training unit 310, the backward map generation unit 320, and/or the image generation unit 330 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

In embodiments, the processing circuitry may perform some operations (e.g., the operations described herein as being performed by the document image distortion correction model 420, the encoder 422, the classifier 424, and/or the decoder 426) by artificial intelligence and/or machine learning. As an example, the processing circuitry may implement an artificial neural network (e.g., the document image distortion correction model 420, the encoder 422, the classifier 424, and/or the decoder 426) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, the machine learning model (e.g., the document image distortion correction model 420, the encoder 422, the classifier 424, and/or the decoder 426) may have any structure that is trainable, e.g., with training data. For example, the machine learning model may include an artificial neural network, a decision tree, a support vector machine, a Bayesian network, a genetic algorithm, and/or the like. The machine learning model will now be described by mainly referring to an artificial neural network, but embodiments are not limited thereto. Non-limiting examples of the artificial neural network may include a convolution neural network (CNN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although the present disclosure has been described in connection with certain examples, various modifications and changes may be made without departing from the scope of the present disclosure, which will be understood by those skilled in the art to which the present disclosure pertains. In addition, such modifications and changes should be considered as falling within the scope of the appended claims of the present disclosure.

What is claimed is:

1. A method performed by at least one processor for training a document image distortion correction model, the method comprising:
receiving a first grid dividing a document area into multiple cells on a first image comprising the document area;
based the first grid, generating a second grid representing a state in which a distortion of the first image is corrected;
generating a backward map calculating a pixel in the first grid corresponding to each pixel in the second grid; and
training a document image distortion correction model to generate the backward map from the first image.

2. The method of claim 1, wherein a slope of horizontal lines and a slope of vertical lines of the first grid are determined based on a direction of text included in the document area.

3. The method of claim 1, wherein the generating of the second grid includes generating multiple first patches representing the multiple cells divided by the first grid.

4. The method of claim 3, wherein the generating of the second grid further comprises:
generating the second grid comprising multiple cells in a horizontal rectangular shape, based on an average of coordinate values of edge points of the first grid and an average of intervals of the multiple cells; and
generating multiple second patches representing the multiple cells divided by the second grid.

5. The method of claim 3, wherein the multiple first patches include multiple triangle patches generated by applying Delaunay triangulation to multiple points included in the first grid and four vertices of the first image.

6. The method of claim 4, wherein the multiple second patches include multiple triangle patches generated by applying Delaunay triangulation to multiple points included in the second grid and four vertices of a second image.

7. The method of claim 4, wherein the generating of the backward map comprises:
calculating a transformation matrix from each of the multiple second patches to each of the multiple first patches; and
generating the backward map based on the transformation matrix.

8. The method of claim 1, wherein the document image distortion correction model corresponds to an encoder-decoder-based deep learning model capable of learning to output the backward map based on the first image.

9. The method of claim 1, further comprising:
in case that the first image comprises multiple document areas, determining one of the multiple document areas as a document area to be subjected to distortion correction; and
determining other document areas of the first image as a background area.

10. A document image distortion correction method performed by at least one processor, the method comprising:
receiving a first image including a document area;
generating a backward map for correcting a distortion of the first image by using a document image distortion correction model; and
based on the backward map, generating a second image obtained by correcting the distortion of the first image.

11. The method of claim 10, wherein the document image distortion correction model corresponds to a machine learning model trained based on,
a first grid dividing a document area in an input image into multiple cells,
a second grid generated based on the first grid and representing a state in which a distortion of the first image is corrected, and
a backward map calculating a pixel in the first grid corresponding to each pixel in the second grid.

12. The method of claim 11, wherein the backward map corresponds to a transformation matrix from each of multiple second patches generated from the second grid to each of multiple first patches generated from the first grid.

13. The method of claim 12, wherein the multiple first patches include multiple triangle patches generated by applying Delaunay triangulation to multiple points included in the first grid and four vertices of the first image.

14. The method of claim 12, wherein the multiple second patches include multiple triangle patches generated by applying Delaunay triangulation to multiple points included in the second grid and four vertices of the second image.

15. The method of claim 10, wherein the document image distortion correction model comprises a classifier configured to determine whether a distortion exists in an input image.

16. The method of claim 15, wherein the classifier calculates a distortion score of the first image, and
wherein the document image distortion correction model is pretrained to output one of the backward map or the first image based on the calculated distortion score.

17. The method of claim 10, further comprising:
removing an empty area in the second image.

18. The method of claim 10, further comprising:
extracting text from a document area in the generated second image; and
translating the extracted text into text in a different language from the language of the extracted text.

19. A non-transitory computer-readable recording medium storing a computer program that, when executed by a computer, causes the computer to perform the method according to one of claim 1.

20. An information processing system comprising:
a communication module;
a memory; and
at least one processor connected to the memory and configured to execute at least one computer-readable program included in the memory,
wherein the at least one program comprises instructions for,
receiving a first grid dividing a document area into multiple cells on a first image comprising the document area,
based on the first grid, generate a second grid representing a state in which a distortion of the first image is corrected,
generate a backward map calculating a pixel in the first grid, corresponding to each pixel in the second grid, and
train a document image distortion correction model to generate the backward map from the first image.
